(19) United States
(12) Patent Application Publication
(10) Pub. No.: US 2009/0012992 A1
(43) Pub. Date: Jan. 8, 2009

(54) Digital Content Metadata Registry Systems and Methods

(76) Inventors: Gurminder Gill, Ronton, WA (US); Jeff Davis, Kirkland, WA (US); Peeyush Ranjan, Sammamish, WA (US)

Correspondence Address: AXIOS LAW GROUP. PLLC, 1525 FOURTH AVENUE, SUITE 800, SEATTLE, WA, 98101, US

(21) Appl. No.: 12/160,733

(22) PCT Filed: Jan. 16, 2007
(86) PCT No.: PCT/US07/60597

§ 371 Date: Jul. 11, 2008

Related U.S. Application Data
(60) Provisional application No. 60/867,158, filed on Nov. 24, 2006.
(60) Provisional application No. 60/867,058, filed on Nov. 22, 2006.
(60) Provisional application No. 60/867,075, filed on Nov. 22, 2006.
(60) Provisional application No. 60/766,370, filed on Jan. 13, 2006.

(51) Int. Cl. G06F 17/30

(52) U.S. Cl. 707/103 R; 707/E17.055

(57) ABSTRACT

The present invention relates to the field of data management and publishing. In particular, this invention relate to an identification registry method for use in storing, retrieving, aggregating, and associating identifiers for digital content. The method comprises steps of maintaining a content registry of digital content records corresponding to digital content file, generating a unique record identifier for each digital content record, and if alternative identifiers corresponding to the digital content files are provided, associating the alternative identifiers with the digital content records.

### RELATED APPLICATIONS

This application is a non-provisional patent application claiming the benefit of U.S. Provisional Patent Application No. 60/766,370 entitled DIGITAL CONTENT DELIVERY ASSISTANCE SYSTEM AND METHOD with the named inventors Gurminder Gill, Jeff Davis and Peeyush Ranjan filed on Jan. 13, 2006; U.S. Provisional Patent Application No. 60/867,075 entitled UNIVERSAL DIGITAL CODE FOR UNIQUE CONTENT IDENTIFICATION with the named inventors Gurminder Gill and Jeff Davis filed on Nov. 22, 2006; U.S. Provisional Patent Application No. 60/867,058 entitled DIGITAL CONTENT REGISTRY with the named inventors Gurminder Gill, Jeff Davis filed on Nov. 22, 2006; and U.S. Provisional Patent Application No. 60/867,158 entitled METHOD AND SYSTEM FOR METADATA NORMALIZATION, ASSOCIATION AND REGISTRATION FOR DIGITAL CONTENT with the named inventors Gurminder Gill, Jeff Davis filed on Nov. 24, 2006, all of which are hereby incorporated in their entirety by reference.

### FIELD

The present invention relates to the field of data management and publishing. In particular, this invention relates to an identification registry for use in storing, retrieving, aggregating, and associating identifiers for digital content.

### BACKGROUND

Due to recent advances in technology, computer users are now able to enjoy many features that provide an improved user experience, such as playing various media and multimedia content on their personal or laptop computers and personal music devices, such as MP3 players, cellular phones and the like. For example, most computers today are able to play digital music files so users can listen to their favorite musical artists while working on their computers (or other devices). Many computers are also equipped with compact disc (“CD”) or digital versatile disc (“DVD”) drives enabling users to listen to music or watch movies.

As users become more familiar with advanced features on their computers, such as those mentioned above, their expectations of the various additional innovative features will undoubtedly continue to grow. Users often desire to receive media metadata, which includes content-related data associated with digital media files such as those from CDs and DVDs. Independent data providers (“IDPs”), such as Loudeye Corporation and All Media Guide (“AMG”) of Alliance Entertainment Corp., capture a vast amount of information related to music CDs and other digital media. IDPs usually enter the collected data manually and store and manage the data using their own particular data entry application. IDPs generally use different formats for identifying content. Those skilled in the art are also familiar with media metadata services that collect information from users when metadata for a specific, requested media file is unavailable from an IDP. For example, consider a media player software application that enables a user to play a CD on his or her computer. Typically, the application allows the user to display track information associated with the CD by clicking on an appropriate user interface (UI). Such track information may include track number, song title, playing time, and the like.

The wide and varied tastes of computer users in music, movies, and the like create the need for an enormous corpus of metadata. As such, data publications of media metadata tend to be very large and experience a high volume of query traffic (e.g., several multi-gigabytes in size and under constant access). Also, the same logical content may have many different physical representations, which makes it difficult to identify and retrieve the correct media metadata for a specific media file. Moreover, the same piece of content from different data providers and/or in different cultures may be identified differently. These problems complicate the storage, management, and retrieval of media metadata, particularly in the context of a large database with data collected from multiple sources.

Conventionally merchants keep track of inventory using Stock Keeping Units (“SKUs”), which are identifiers that are used by merchants to permit the systematic tracking of products and services offered to customers. Usage of the SKU system is rooted in the drill down method, pertaining to data management. SKUs are assigned and serialized at the merchant level. Each SKU is attached to an item, variant, product line, bundle, service, fee or attachment.

SKUs are not always associated with actual physical items, but are more appropriately billable entities. Extended warranties, delivery fees, and installation fees are not physical, but have SKUs because they are billable. All merchants using the SKU method will have their own personal approach to assigning the numbers, based on regional or national corporate data storage and retrieval policies. SKU tracking varies from other product tracking methods which are controlled by a wider body of regulations stemming from manufacturers or possibly third-party regulations.

Consider this: a ball has a part number of 1234, it is packed 20 to a box, and the box is marked with the same part number 1234. The box is then placed in the warehouse. The box of balls is the SKU, because it is the stocked item. Even though the part numbers are interchangeable to mean either a ball or a box of balls, the box of balls is the stocked unit. There may be three different colors of balls; each of these colors will be a separate SKU. When the product is shipped, there may be 50 boxes of the blue balls, 100 boxes of the red balls, and 70 boxes of the yellow balls shipped. That shipment would be said to have been a shipment of 220 boxes, across three SKUs.

Successful inventory management systems assign a unique SKU for each product and also for its variants. For example, different flavors or models of product, or different bundled packages including a number of related products, have independent SKUs. This allows merchants to track, for instance, whether blue shirts are selling better than green shirts.

International Standard ISO 15707, published by the International Organization for Standardization (ISO) on Nov. 15, 2001, provides one scheme for identifying a logical piece of work. In general, ISO 15707 defines the format, administration, and rules for allocating an international standard musical work code (“ISWC”) to a musical work. The ISWC uniquely distinguishes one musical work from another within computer databases and related documentation for those involved in the administration of rights to musical works. The standard's goal is to reduce errors when information about musical works is exchanged between rights societies, publishers, record companies, and other interested parties on an international level. As defined in ISO 15707, the ISWC includes a prefix element followed by a nine-digit numeric code and a check digit. Unfortunately, this standard focuses on rights management rather than data management and aggregation and is limited in scope to musical works. Moreover, the existing standard does not provide for associating and mappings related identifiers, which is important when providing useful media metadata.

Similarly, the International Standard Recording Code (“ISRC”), defined by ISO 3901, is an international standard code for uniquely identifying sound recordings and music video recordings. In general, ISO 3901 defines the format, administration, and rules for allocating an ISRC to a musical work. The ISRC uniquely distinguishes one musical recording from another within computer databases and related documentation for those involved in the administration of rights to musical recordings. The standard's goal is to reduce errors when information about musical recordings is exchanged between rights societies, publishers, record companies, and other interested parties on an international level. As defined in ISO 3901, ISRC codes are twelve characters long, in the form “CC-XXX-YY-NNNNN” (The hyphens are not part of the ISRC code itself, but codes are often presented that way in print to make them easier to read.) The four parts are as follows:
“CC” is the appropriate for the registrant two-character ISO 3166-1 alpha-2 country code.
“XXX” is a three character alphanumeric registrant code, uniquely identifying the organization which registered the code. Typically, the appropriate regulating body in each country will issue a three letter code to each record label. For example, the regulating body for ISRCs in the UK is Phonographic Performance Ltd.
“YY” is the last two digits of the year of registration (NB not necessarily the date the recording was made).
“NNNNN” is a unique 5-digit number identifying the particular sound recording.

An example, a recording of the song “Enquanto Houver Sol” by the Brazilian group Titãs has been allocated the ISRC code BR-BMG-03-00729:
BR for Brazil.
BMG for BMG.
03 for 2003.
00729 is the unique id identifying this particular recording.

Another proposed identifier is the Global Release Identifier (“GRid”), which is an identifier that identifies electronically distributed music. These releases may be single tracks, an album or multi-media packages. GRid was created because tracks are being traded and released electronically with no standard means of identifying them. Many of the parties involved use different identifiers, which makes communication about the assets and their tracking through the value chain very difficult. GRid is a standard means of identifying the fundamental unit of trade in the electronic environment—the release. Unlike the ISRC, which identifies individual sound and music video recordings, the GRid identifies the product or release that these recordings are part of. For example: The same song on the release of an album and on a greatest hits compilation has the same ISRC, but the two releases will have different GRids. Grids are alphanumeric, 18 characters in length and have a fixed format. The first two parts are allocated by the GRid Registration Agency and the last two by the user themselves. The parts are:
Schema Identifier—always set at A1 to denote this is a recording industry release
Issuer Code—five characters—identifies the entity allocating GRids to releases
IP Bundle Number—10 characters—identifies the particular release
Check Digit—a calculated value that ensures it has not been corrupted

An example of a GRid is:
A1-2425G-ABC1234002-M.

Those skilled in the art are also familiar with various tagging schemes for identifying digital content. For example, an ID3 tag residing at the end of an audio file can include title, artist, album, year, genre, track, and a comment field. In other words, known tagging systems embed data about the content directly in the content. The problem is that this metadata can become stale and even incorrect. While the ID3 standard provides for an identifier, it is merely a placeholder and there is no specification on how it is to be used. Moreover, existing tagging schemes also fail to address associations and mappings between identifiers. In particular, as rights-holders pass along the right to resell/broadcast/modify or otherwise make use of content, none of these identify and/or metadata systems allow for the inheritance of rights, rules and restrictions on content.

The ever-changing marketplace is constantly influenced by the Internet and the manner in which digital content, such as music files, movie files, pictures, ringtones, etc., is bought, transferred and sold. As more and more computers and hand-held devices become universally compatible with all manner of computer networks, the ability to use and transfer digital content across different device platforms is becoming more prevalent. As a result, it has become difficult at times to keep track of the manner and extent to which digital content is disseminated and consumed in such a vast and undefined networking world.

The fragmentation of the retail market for digital content is represented by the millions of content items from thousands of content providers all written to take advantage of the specific characteristics of different devices, protocols and platforms. There is typically a lack of data defining the qualities of each requirement for the device, content type, network and operating system and how they might interoperate together. There has yet to be a provider that can scale to support any device and content type and offer the consumer a user friendly experience of assistance in delivering and installing digital content for a digital device.

It is difficult for a consumer of digital content to understand the delivery and installation of digital content on digital-content-enabled device. Service providers have not generated a user-centric experience to assist the consumer in understanding the delivery and installation process of digital content for digital devices.

One example is a typical mobile handset market in which common practice is for service providers to facilitate management of devices by having detailed information on the media and protocol characteristics of the device and uses. The service providers use such information to ensure content and information sent to the consumer's device are best fitted to their device characteristics. The device information is used for optimal mapping of digital content to devices and for the optimal selection of delivery and notification mechanism per device.

In the mobile handset market, there is a wide variety of media formats, discovery methods and delivery options. As but one example, mobile devices can typically support the following media formats and delivery protocols: Games and Applications: Java J2ME, Symbian, Smartphone, Palm; Images: JPEG, BMP, PNG, WBMP, GIF, NOL, NCOL, NGG; Audio: MIDI, iMelody, AMR, MP3, MC, SMAF; Video: 3GP, RealMedia, MPEG-4. As another example, mobile devices can typically support the following delivery methods: SMS, MMS, E-mail, WAP Push, Audio/Video Streaming, HTTP and the like.

However, mobile service providers have not assisted the user by walking them through the process of purchasing, downloading and installing specific digital content for specific devices. From a consumer's perspective, it is difficult to understand the status of the delivery and, once the digital good is delivered to the device, how to find content on the device and how to install content so that it can be used, played, heard and or viewed.

This may be exemplified by a real-world example wherein a user purchases a T-Shirt, a physical good, from TShirtsRUs, a t-shirt merchant storefront. The user chooses size and color, completes payment and requests delivery to Seattle. The shipping information is supplied to the delivery service FedEx. FedEx provides user with an expected arrival date and intermediate tracking information for goods in transit, and the user is easily able to retrieve the t-Shirt from the arrived packaging and begin using it, relying on the information accompanying the goods for usage details such as laundry instructions.

Another user purchases the same t-shirt, to be delivered to New York. The experience is essentially similar and no new learning is required on user's behalf.

In contrast, in the digital world today, a user purchases a digital good, a music video, to be delivered on a certain device, their handheld Samsung phone. The user determines that among the three different formats and screen sizes, there is one specific one that will work on their device. Then they complete a purchase transaction for that SKU. The merchant storefront processes the transaction and passes the good over to the communication provider, which is their ISP or wireless carrier. The user either receives the item ordered immediately or after some delay. When there is a delay, user is not provided with a means to track the bits as they travel through the system. The user receives the music video, but the usage of that good on the specific device in question is not provided along with the video file, and the Samsung device manuals need to be referenced to understand how to install and play the received video.

Another user purchases the same video to be delivered to another device, their Video iPod®. The other user has to determine which SKU will work with their device and, upon purchase, the experience varies widely ranging from the method of receipt to process of installation. In many cases there is no information provided for compatibility with the device, specifically if the device has been produced after the digital good. Due to these variations in devices and their capabilities, the merchant is not able to provide a common experience across all digital good-device pairs.

In addition to these user problems discussed above, merchants also suffer from the ability to track differing digital content due to the convoluted manner in which digital content may typically be delivered. That is, it is often the case that a seller of digital content does not maintain the ability to track specific digital content once a distributor/operator delivers the digital content. For example, a seller, such as Disney, may have several ringtones that are available for purchase through an operator, such as Verizon. When Verizon makes a sale of a Disney ringtone to one of its customers, Verizon tracks that a Disney ringtone has been sold, but does not identify which particular ringtone has been sold. Thus, Disney, during a given period of time may come to know that Verizon has sold 1000 Disney ringtones to Verizon customers, but Disney is not able to track which particular ringtones are amongst the 1000 sold. It would certainly be beneficial for Disney to be able to track which ringtones are outperforming others in the marketplace.

As a result, digital content is not able to be tracked from content owner to content purchaser through the countless possible channels in which digital content may distributed.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a digital content registry system in accordance with one embodiment.

FIG. 2 is a block diagram of an automated content ingestion system in accordance with one embodiment.

FIG. 3 is an exemplary diagram of a content registry server in accordance with one embodiment.

FIG. 4 is a diagram illustrating the actions taken by devices in a content registry system for ingesting content in accordance with one embodiment.

FIG. 5 is a flowchart illustrating a process for content ingestion in an embodiment.

FIGS. 6a-b illustrate various Universal Digital Code formats in accordance with various embodiments.

### DETAILED DESCRIPTION

One approach to solving these problems is by taking an open, top-down approach and developing a object-oriented database architecture that defines how all types of digital content will be classified, organized, found and delivered—in a manner that is extensible and scalable. Upon this object-oriented database (sometimes called a content registry) is built a object-oriented platform, which allows a provider to execute semantic processes that allow it to generate a meaningful experience for the end user.

There are significant differences in the way the metadata for physical goods is managed versus the metadata for digital goods. Metadata for digital content typically contain very specific information such as device, format, file size, description, etc. that needs to be organized in a way that is critical to ensuring the right content gets to the right device. Today, metadata for digital content is not standardized in the way that it has been for physical goods and is often missing critical elements. The characteristics of digital content and its metadata define the ways in which one can classify this information in order for it to be processed independently of the application, platform or device. Once this information is understood and organized, new relationships can be formed between the different digital content and devices such that the user experience is enhanced to rival that of the physical goods delivery world.

Described below is a content metadata system employing a content metadata registry to capture metadata around content, devices, rules, and consumers. In one embodiment, the content metadata registry includes a object-oriented database which creates associations around rules.

Content Metadata Registry: metadata in the content metadata registry provides for both the technical documentation of data and the business rules associated with the content. The content metadata registry leverages a classification system that formally defines the hierarchies and relationships between different attributes, creating a system of classification that makes it very easy for the platform to scale quickly by adding new content types, rules and or devices and consumer information.

Furthermore, the content metadata registry has an association database that stores, finds, interprets, combines and acts on information for multiple content items, devices, and their associations. It also allows creation of new associations that can generate new content offerings/bundles.

Additionally, the nature of digital content offers advantages that can enhance the user experience by providing a similar experience independent of the digital good, purchase platform, delivery service or end device. In fact, a digital meta data registry can have applications and services which can leverage the registry to allow commerce applications, communication applications, community applications, viral applications, content Interoperability, content sharing, content shifting, time shifting, recommendation, search, advertising, promotion, personalization, advertising, digital rights management, affiliate networks, reporting, reconciliation, tracking, data manipulation, business reporting, age verification, auditing, providing coupons, providing storage, and providing warranties.

The object-oriented platform allows building and querying of the object-oriented database from large amount of content and devices and connects that information with data in other non-interoperable information repositories. Using it, the system is able to find, interpret, combine and act on information from multiple sources through structured sets of information and inference rules that allow it to ‘understand’ the relationship between different data resources and make logical connections. Further, semantic processes enable the system to process, transform, assemble and even act on the data in useful ways.

The result of such technology is that the digital content purchase, delivery and installation processes can be made simpler such that any complexity is insulated from the end user. The user experience may be streamlined to enable a user to browse among and select a music video as an item to purchase for their Samsung phone. The user is not required to know beforehand and specifically choose the format that will work with their device. However, when the user does select the delivery end point, the object-oriented database is able to infer which of the many possible SKUs will work with this device. The user is not requested for any information, and instead is told how the bits will arrive to their system. The system then is able to infer the best delivery option, which in this case is through local machine's Bluetooth capability. The system then executes a Bluetooth ActiveX control that transfers the video to the user's mobile phone. The system is also able to infer from the digital content type, and the end delivery point, what kind of use cases are possible, and hence automatically configures the end device to accept and install the received video and provides the user with the instructions on how to enjoy the content which has been chosen.

The second user comes and selects the same music video to be delivered over video iPod. The system automatically infers the right SKU with the correct format and digital rights management scheme, without the user having to select among many similar looking SKUs. The delivery process in this case is different, but the system infers the invocation mechanism that is most appropriate for a video to be sent to the video iPod end device, and is able to initiate that kind of delivery. In cases where possible, the system also registers for a status notification and updates the user on the status of the delivery process. Finally, when the content arrives on the device, the system configures it for appropriate use and provides the user with information on how to begin enjoying the content.

As can be seen, through use of its object-oriented technology, a content provider is able to provide a consistent experience across a number of variable platforms by taking care of the fragmented environment through semantic inferences. The domain data is made of many different objects in each type set and to build a comfortable end user experience, the system has a need to organize all the possible variations in a meaningful manner in a digital content registry.

Since this solution is to provide a seamless purchase experience starting from any discovery channel, examples of which include a website storefront or a bookmark on a mobile device, purchasing any digital content, examples of which include videos and games, going through any delivery channel, examples of which include a wireless or wired internet service provider, reaching any device, examples of which include a mobile phone or a gaming console, the various digital objects in the system are organized accordingly.

Whenever organizing any set of objects, one may use the object-oriented model, whereby any two objects are typically related through an association. This modeling usually takes the form of <object><association><object>. For example: <Ringtone><is a kind of><audio file>. <Midi 4><is a format of><audio file>. These kinds of associations allow one to infer other kinds of associations. For example, from the above two associations, the system can infer: <midi 4><is a format of><Ringtone>.

This kind of association and inference mechanism provides the basis to organize, classify, infer from and act upon a variety of data once the data itself stored them in the object-oriented database.

One example assimilation process is followed across all varieties of objects such that the objects are organized in the system using a classification system that may be used to create associations between different objects. These associations then result in inferences that can be drawn to drive the other semantic processes.

In this process of providing the seamless experience across discovery mechanisms, digital good types, delivery mechanism and end devices, a basis for an approach is assimilation and organization of the digital content. The general organization process classifies the digital content based on one or more hierarchical relationships representing typical associations such as, for example, ‘is’, ‘has’, ‘has many’, ‘is like’, ‘formatted as’, ‘similar to’, etc. These associations can apply to the type of the digital content, as well as to specific types of such digital content.

The seamless experience in the situation above allows a user to easily find the various kinds of ringtones by looking at various audio section of the content catalog, while not having to worry about where the content type semantics end and where the formatting semantics begin. Instead, once the user finds the ringtones, the various formats can be investigated and inferred by the system by looking at the devices where the user might want the goods delivered.

Using the above data structure, the system can guide a user who is viewing or purchasing a Splinter Cell PC game to the same game available in a different format. Alternatively, the system can also infer that a user that plays Splinter Cell game is also likely to watch the Bourne Identity movie clip and hence can provide a seamless content discovery process which suits the user's taste.

Similar to how digital content is organized, metadata about specific devices may also be assimilated and organized. However, with devices, the associations may be very different. The associations with use-devices are tied to the capabilities of the device itself, and can result in associations such as ‘supports’, ‘compatible with’, ‘has’, ‘capable of’ and ‘allows’. Such an organization tells the system what a device can support, its compatibilities, and its features.

These two data structures are then connected to each other through four different processes of generating new semantic associations. These four processes include:
(1) Content device mapping: Creates associations between existing contents and devices.
(2) Content adaptation: Creates associations between contents and devices in a manner that creates new content formats that can then be fed into the content device mapping system.
(3) Content correlation: creates associations between different pieces of contents.
(4) Device correlation: creates associations between different types of devices.

Once these four system associations are up and running, the object-oriented platform may further allow a user and/or vendor specific functionality as follows:
(1) User comes to a discovery terminal.
(2) The system understands the discovery terminal and infers the kind of form user will need to fill to authenticate with the system. Examples include a web form on the internet, or a client form on a dedicated rich client such as PC or Xbox.
(3) The user fills the form and authenticates with the system, and begins the browsing experience.
(4) The user is shown content pieces of interest by navigating through associations of interest and irrelevant associations such as formats are hidden from the user. Such interest points can start from content types such as “games” or “ringtones,” or devices such as “phones” or “gaming consoles,” or use cases “want to watch a video” or “want to listen to music.”
(5) As the user navigates through the system and narrows down the contents of interest, the associations with other contents are brought into the system shortlist as something of potential interest to the user. The type of items brought into the system shortlist can be based on any of the various associations such as “similar,” “supports”, “compatible with” etc.
(6) Once the user picks the content of choice and the end point device, the compatible formats, if applicable, are automatically determined based on the device chosen by the user as the end point, based on the ‘supports’ and ‘compatible with’ associations, among others.
(7) The user continues the purchase process, provides payment and requests delivery. The device association with data delivery mechanisms provides the information needed on how to interact with the delivery system. The choice of delivery system is made based on which discovery and purchase terminal is the user associated with, what good he or she has chosen and to what end device the digital good is supposed to be delivered.
(8) The user's discovery/purchase terminal and the delivery system are both notified of the pending delivery and the system continuously updates the discovery/purchase terminal based on the status reports from the appropriate delivery system.
(9) When the digital content arrive on the end device, the system accesses the end device, configures it for usage of the content, and checks it against success criteria. The means to access the end device and perform such tests depends on the use cases and capabilities associated with the device. Some examples of this process include using a host installer, such as operating system application installers, or a dedicated client running on the end device, remote access APIs, or simple end user installation instructions.
(10) The usage instructions are determined on the associations between the digital goods, the end device it is meant for, and the use cases associated with that end device. The set of instructions are delivered to the end device as well as the discovery terminal.

An example a simple use case for a recommendation service using the registry may include the following actions:
(1) User refers content from carrier deck with a API call to the registry
(2) Registry send a referral message with FulIfillmentID
(3) Target user responds, registry calculates dynamic mapping and responds with a Universal Digital Code (“UDC”)
(4) User purchases & downloads content
(5) Registry receives Download ACK, or final packet to signify “complete” or “Stop, no errors”
(6) Registry records transaction with the ACK

In this use case, digital content registry provides a inter carrier recommendation solution as it holds content from common content from multiple different aggregators. Content is matched dynamically for the target device (UAProf), carrier with the help of parameters like content tile, UDC etc.

At the end of this process, the user has had a smooth experience from beginning to end, and this experience is repeated for every user who comes to a provider, irrespective of their discovery terminal, content type being purchased, the delivery method and the end device.

A possible application of such a content registry system is the inter carrier recommendation solution. Content can be referred from one device to another which could be on a separate network. All the complexities involved in calculating the content mapping for the target carrier, device, firmware will be handled by the registry. This is possible since registry has content semantically aggregated from multiple different providers, operators with associated rules to recommendation & sharing.

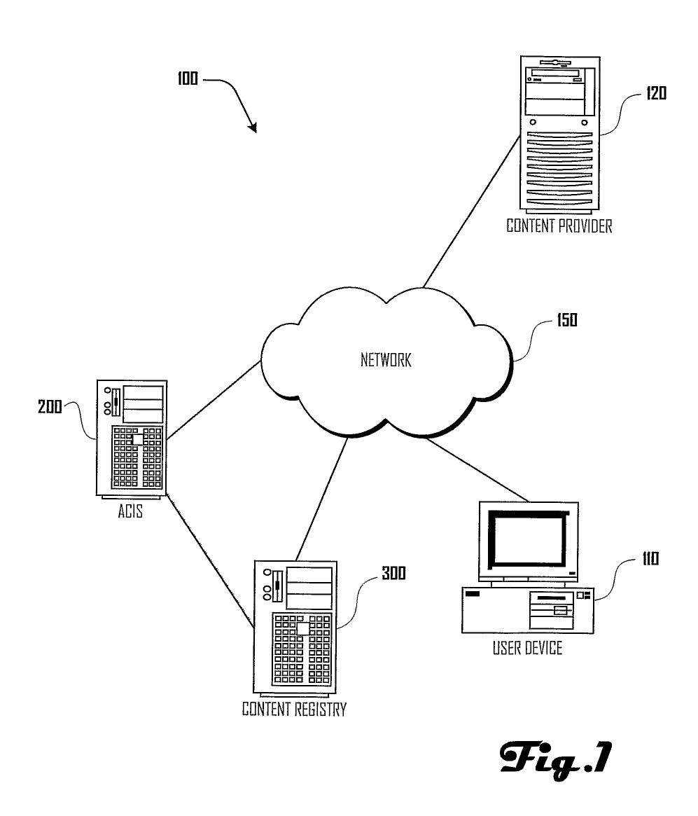

With such a object-oriented database, a system may be implemented according to FIG. 1. In this system, a content supplier 120 may provide digital content to a content registry 300 through and automatic content ingestion system (ACIS 200). Through a set of specific data handling parameters and protocols, all content supplier 120 content may be ingested to the content registry 300. Once digital content is ingested, data about the content available to the system may be queried such that any number of associations are identifiable and actionable. For example, one may wish to locate all ringtones having something to do with The Rolling Stones or all ringtones available to Sprint devices. Operators may also query the database on behalf of a user such that the content registry may provide details to an operator about various digital content that may be available. In short, both content suppliers and content consumers may access and query the content registry in an effort to gain more information about available digital content.

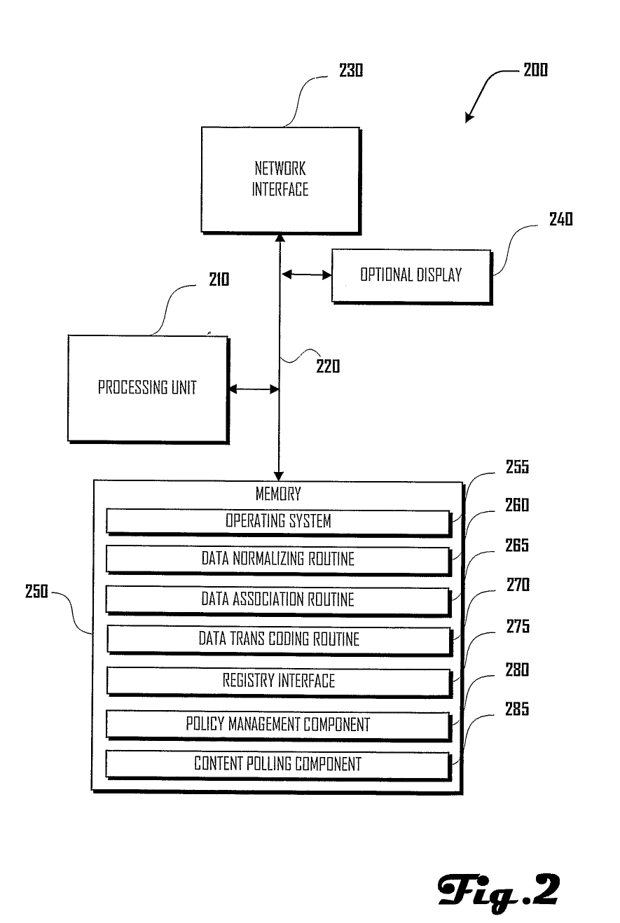

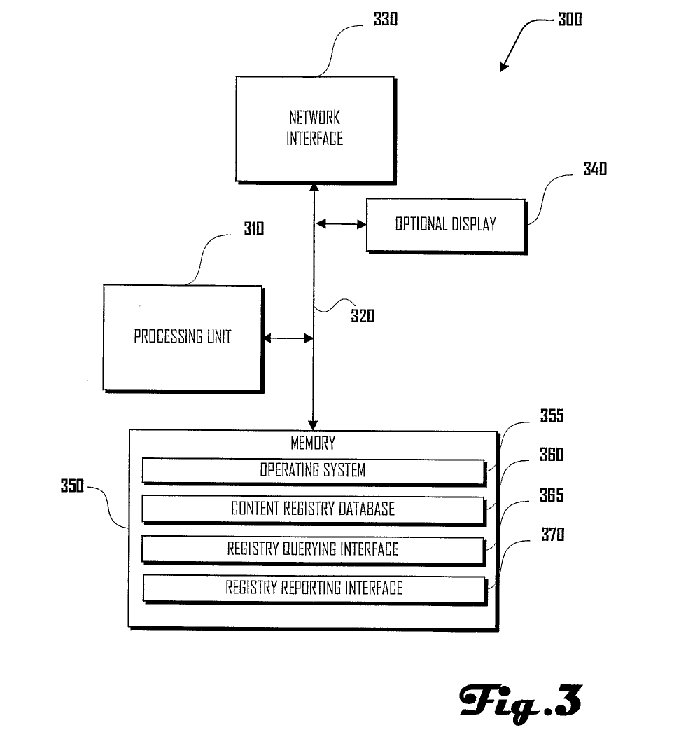

FIG. 1 illustrates an exemplary digital content registry system 100 having a number of devices used in exemplary embodiments. FIG. 1 illustrates a content registry 300, illustrated in FIG. 3 and described below, connected to a ACIS 200, illustrated in FIG. 2 and described below, a network 150 (such as a local or wide area network, e.g., the Internet or the like) and a content provider 120.

In further embodiments, still additional devices (not shown) may be utilized in the digital content registry system 100. Likewise, in some embodiments, other devices (both shown and not shown) may be combined. For example, the ACIS 200 and content registry 300 may be in the same device.

FIG. 2 illustrates several of the key components of the ACIS 200. In some embodiments, the ACIS 200 may include many more components than those shown in FIG. 2. However, it is not necessary that all of these generally conventional components be shown in order to disclose an illustrative embodiment. As shown in FIG. 2, the ACIS 200 includes a network interface 230 for connecting to other devices in the digital content registry system 100. In various embodiments, the network interface 230 includes the necessary circuitry for such a connection and is constructed for use with the appropriate protocol.

The ACIS 200 also includes a processing unit 210, a memory 250 and may include a display 240, all interconnected along with the network interface 230 via a bus 220. The memory 250 generally comprises a random access memory (“RAM”), a read only memory (“ROM”), and a permanent mass storage device, such as a disk drive. The memory 250 stores the program code necessary for a data normalization routine 260, data association routine 265, data transcoding routine 270, a registry interface 275, a policy management component 280 and a content polling component 285. In addition, the memory 250 also stores an operating system 255. It will be appreciated that these software components may be loaded from a computer readable medium into memory 250 of the ACIS 200 using a drive mechanism (not shown) associated with a computer readable medium, such as a floppy disc, tape, DVD/CD-ROM drive or via the network interface 230.

Although an exemplary ACIS 200 has been described that generally conforms to conventional general purpose computing devices, those of ordinary skill in the art will appreciate that a ACIS 200 may be any of a great number of devices capable of communicating with the device within the digital content registry system 100.

Through the ACIS, various types of metadata like Content Metadata, Rules metadata, Devices Metadata etc. are inserted into the content registry. Rules metadata describes various policies around the content which cover areas like Usage, Reporting, and Tracking etc. Rules metadata reside within the registry and are associated semantically with the content metadata. These associations help determine rules around content retrieval, transmission, delivery, consumption etc.

These rules can be set up dynamically using web interfaces such as Publisher Central (described below)—role players within the registry. For example, publishers can restrict access to a certain SKU or a category of SKUs or a collection of SKUs for a particular reseller. Or a reseller who has subscribed to multiple contents can control consumption of content through various applications like store, locker, recommendation etc.

FIG. 3 illustrates several of the key components of the content registry 300. In some embodiments, the content registry 300 may include many more components than those shown in FIG. 3. However, it is not necessary that all of these generally conventional components be shown in order to disclose an illustrative embodiment. As shown in FIG. 3, the content registry 300 includes a network interface 330 for connecting to other devices in the digital content registry system 100. In various embodiments, the network interface 330 includes the necessary circuitry for such a connection and is constructed for use with the appropriate protocol.

The content registry 300 also includes a processing unit 310, a memory 350 and may include a display 340, all interconnected along with the network interface 330 via a bus 320. The memory 350 generally comprises a RAM, a ROM, and a permanent mass storage device, such as a disk drive. The memory 350 stores the program code necessary for a content registry database 360, registry querying routine 365, and a registry reporting routine 370. In addition, the memory 350 also stores an operating system 355. It will be appreciated that these software components may be loaded from a computer readable medium into memory 350 of the content registry 300 using a drive mechanism (not shown) associated with a computer readable medium, such as a floppy disc, tape, DVD/CD-ROM drive or via the network interface 330.

Although an exemplary content registry 300 has been described that generally conforms to conventional general purpose computing devices, those of ordinary skill in the art will appreciate that a content registry 300 may be any of a great number of devices capable of communicating with the device within the digital content registry system 100.

Within the context of the content registry, all stored data and all digital content may have layers upon layers of associations such that specific associations may be inherited and maintained (similar to object-oriented programming object inheritance). In this manner, content stored in the digital registry may maintain specific associations, e.g., a Rolling Stones ringtone as provided by Sony as opposed to any non-descript Rolling Stones ringtone. Furthermore, additional layers of association may be maintained and inherited, e.g., a Rolling Stones ringtone provided by Sony and formatted to be compatible with a Sprint mobile phone.

Such a content registry may be further associated with a software application that allows for easy navigation and access to the data stored therein. The user of this application may have a role of publisher, reseller, or combination of both (publisher/reseller). Depending on the role of the logged on user, the contents of the presented data will change.

The default page for this site may be a login page. On each of the pages, checks may be made to see if the user/vendor has logged in or the session is active, else the user may be redirected to the login page. The login page enables vendors to log in to the Vendor Application system after entering the Email ID and password. This page may further include a ‘forgot password’ link. Upon clicking the ‘Login’ button, the authentication of the user takes place. Depending on the role of the logged in vendor, he/she will be shown a page. Irrespective of the role of the logged in user, the user will first be taken to the ‘Home’ page.

Tables used for various logged-in identification may be as follows. The header section for the Publisher login may include tabs entitled:
(1) Home
(2) Manage Contents
(3) Manage Subscription
(4) Manage Ingestion
(5) Settings.

The header section for the Reseller login may include tabs entitled:
(1) Home
(2) Manage Subscribed Contents
(3) Manage Subscription
(4) Settings.

The header section for the ‘Publisher-Reseller’ login may include tabs entitled
(1) Home
(2) Manage Contents
(3) Manage Subscribed Contents
(4) Manage Subscription
(5) Manage Ingestion

Settings

These pages are described in detail below.

‘Home’ Page: This page is the default page which will have all the information about the GoGoMo application. This page will be visible to all the users irrespective of their roles.

‘Manage Contents’ Page: This page will show the products uploaded by the Supplier. The page will be used to delete/restore contents along with Subscribe/Unsubscribe contents to Resellers and change the state of content. After the supplier login to the vendor Application, and moves to the Manage Content page, he will be shown contents depending on the filter applied. There are at least four types of filters:
(1) Content Type: A dropdown list with all the Content Types from the gogo_content_type table. When no content type is selected, this filter will not be applied.
(2) Category: A dropdown list with all the categories present in the ‘gogo_category’ table. When no category is selected, this filter will not be applied.
(3) Status: A dropdown list that will have hard coded option. By default ‘Active’ will be selected. This filter will always be applied as either the user will selected ‘Active’ or ‘Deleted’ options.
(4) Reseller: A drop down list that will list down all the active resellers for that publisher. This information will be fetched using the gogo_reseller_subscription table. Check will made to select only the active resellers by checking the ‘dtStart’ and ‘dtExpiry’ fields.

In addition to the above drop down filters, there will be radio buttons as mentioned below:
(1) 1 Granted Radio Button—Selected by default
(2) 2. Denied Radio Button
(3) 3. Both Radio Button.

Depending upon the filters applied the content shown in grid will vary. Supplier can change the option in the “Status” dropdown to filter contents according to the status of Content. Supplier can also filter contents depending on the Reseller. If a specific reseller is selected, the supplier may ‘Grant’ or ‘Deny’ permissions to the contents.

Steps:
(1) Supplier can change status of content (i.e., make the content Active/) by selecting a option in the status dropdown control. If ‘Active’ status is selected in the status dropdown, the ‘Change Status’ button will be called ‘Delete’. If ‘Deleted’ status is selected in the status dropdown then the ‘Change Status’ button will be called ‘Activate.
(2) If “Active” status is selected in the dropdown list, then only Active contents will be shown in the grid. And the button will be called ‘Delete’. It will change the status of the selected contents to ‘Deleted’ in the “i_content_state” field of the “gogo_subcontent”.
(3) If ‘Deleted’ option is selected in the status dropdown list then only contents that are already ‘Deleted’ will be shown in the grid. The ‘Change Status’ button will be called ‘Activate’. On clicking the ‘Activate’ button, the selected contents will be made active by changing the in the “i_content_state” field of the “gogo_subcontent” to 0 i.e. ‘Active’.
(4) If Supplier selects none of the filters like ‘Content type’, ‘Category’, ‘Reseller’ then the supplier will be shown all the contents that are ‘Active’.
(5) If Supplier does not select any reseller in the Reseller filter, in this case the “Permissions” Column will show value as Not Applicable and the “Grant/Deny” button will be disabled, also the 3 radio buttons (Granted Radio Button, Denied Radio Button and Both radio button) will be disabled.
(6) If Supplier selects a specific Reseller, then if “Both” radiobutton will be selected, the Supplier will not be allowed to change the permissions of the contents. In this case, both the “Grant/Deny” button will be disabled.
(7) If Supplier selects a specific Reseller and further selects “Granted” radiobutton, the Supplier will only be seen (the contents that have been granted permission for that reseller). In this case the “Grant/Deny” button will be called “Deny Permission”.
(8) If Supplier selects a specific Reseller and further selects “Denied” radiobutton, the Supplier will only be seen, the contents that have been denied permission for that reseller. In this case the “Grant/Deny” button will be called “Grant Permission”.
(9) Here Subscribe content to Reseller means remove a row with the id_reseller_subs (contextID) and the subscribed content id (id_subcontent) from the gogo_subcontent_NOT table.
(10) Unsubscribe a particular content for a Reseller means add a data row to gogo_subcontent_NOT table for the selected Reseller and content.

‘Manage Subscription’ Page: this page will enable the users to request for new subscription, and well as accept/disapprove the subscription requests. This page will be divided into three sections ‘New Requests’, ‘Subscribe’ and ‘Existing Suppliers’.

Section ‘New Requests’: this section will show the new requests that are made by resellers to him. This section will have a grid with the vendor information as different columns.

The columns of the grid will be:
(1) Reseller—‘v_vendor_name’ from gogo_vendor table
(2) Contact Number—‘v_vendor_contact_no1’ from gogo_vendor table
(3) Email ID—‘v_vendor_email1’ from gogo_vendor table
(4) Start Date—These will be added to dtStart field in the ‘gogo_reseller_subscription’ table. This will indicate start of the subscription period
(5) End Date—These will be added to dtExpiry field in the ‘gogo_reseller_subscription’ table. This will indicate end of the subscription period. This is not compulsory. If it is null it will mean that the subscription does not have a expiry
(6) Selective Approval—This button will enable the publisher to selectively grant the contents for the reseller. Clicking on this button will open a popup window and the user will be able to select the contents that are to be shown to the new reseller.

In addition to the grid there will be there will be command button for approving and disapproving the request. In case of approving, the start date and end date of the subscription can be selected. If the end date is not selected, the subscription will not have expiry date. Since requests are made to the suppliers, this section will be visible to ‘Publisher’ login as well as ‘Publisher-Reseller’ login but will not be visible to ‘Reseller’ login. When the status of the request is changed, i.e. if the publisher/publisher-reseller approves or disapproves the request, a mail will be sent to the vendor who has made a request. When a publisher logs into the system, the total number of new subscription requests that he has will be appended to the ‘Manage Subscription’ tab. E.g., Manage Subscriptions(3)

Tables Used: gogo_reseller_subscription, gogo_vendor. The rows of data with status ‘Requested’ for the logged in publisher, will be shown in this section as new requested. When the subscription request is approved or disapproved the flag in this table will be set to ‘Approved’ or ‘Disapproved’.

Section ‘Publishers: this section will be visible to the ‘Reseller’ login or ‘Publisher-Reseller’ login. This section will have a grid control that shows a list of all the publishers. This grid will have columns list, Name, contact Number, Email ID, Start Date (of subscription) and End Date (end date), Status.
(1) The Publishers to which the reseller has subscribed and have active subscriptions will show the Start and End dates of the subscription. The Status column will show subscribed.
(2) In the start date and end date columns for the publishers to which the reseller has made a request, but whose request is yet to be granted will show ‘NA’ and the status column will show ‘Requested’.
(3) The start date and end date columns for the publishers to whom the request is not made at all will show ‘NA’ and the Status column will have a command button ‘Send Request’. When ‘Send Request’ command button is pressed, a row will be added to the gogo_reseller_subscription table and the status will be set to ‘Requested’. In addition to this, a mail will be sent to the publisher to whom the request is made.

Tables Used: gogo_reseller_subscription, gogo_vendor
‘Manage Subscribed Contents’ Page: this page will show the contents to which a reseller is subscribed to. The page will also be used to assign/unassign contents to “GoGoMo Applications” that a Reseller is subscribed to. After a Reseller login to the vendor Application, and moves to the Manage Subscribed Content page, he will be shown contents depending on the filter applied.

There are at least four types of filters:
(1) Content Type: A dropdown list with all the Content Types from the gogo_content_type table. When no content type is selected this filter will not be applied.
(2) Category: A dropdown list with all the categories present in the ‘gogo_category’ table. When no category is selected this filter will not be applied.
(3) Publisher: A drop down list that will list down all the active publishers for that reseller. This information will be fetched using the gogo_reseller_subscription table. Check will made to select only the active publishers by checking the ‘dtStart’ and ‘dtExpiry’ fields.
(4) Applications: A drop down list that will have a list of GoGoMo Applications assigned to the reseller. This information will be fetched from ‘gogo_appcontrol’ table.

In addition to the above drop down filters, there will be radiobuttons as mentioned before. Depending upon the filters applied the content shown in grid will vary. Reseller can filter contents depending on the Application, and can also grant and deny contents to the Application.

Steps:
(1) If no value is selected in the filter drop downs, then it means that filter will not be applicable.
(2) Reseller can see all the contents that he has subscribed to when he selects ‘None’ in all the filter drop downs.
(3) Reseller can further filter the contents by selecting “Publisher” filter. In this case all the contents that are from this publisher will be shown to the Reseller.
(4) Reseller can now further apply the “Application” filter.
(5) If Reseller does not apply the Application filter, the Permission column will show value as NA and the “Granted/Denied/Both” radiobuttons in the filter will be disabled. Moreover, the Grant/Deny command button will be disabled.
(6) If Reseller selects a specific Application, in that case “Granted” radiobutton will be selected by default and the ‘Grant/Deny’ command button will have caption “Deny”. The reseller can deny the selected contents to the selected Application by clicking the ‘Deny’ command button.
(7) If Reseller selects a specific Application and further selects “Denied” radiobutton, and the ‘Grant/Deny’ command button will have caption “Grant”. The Reseller can only see denied contents of the Application. The reseller grant permission to the contents by clicking on the ‘Grant’ command button.
(8) If Reseller selects a specific Application and further selects “All” radiobutton, the Grant/Deny command button will be disabled. The reseller can only view depending on the filters selected.
(9) Here Grant permission to the content to Application means remove a row with the id_appcontrol (contextID) and the subscribed content id (id_subcontent) from the gogo_subcontent_NOT table.
(10) Unsubscribe a particular content for a Application means add a data row to gogo_subcontent_NOT table for the selected Application and content.
   ‘Manage Ingestion’ Page: This page will be used by the Publisher login and the ‘Publisher-Reseller’ login to upload the xml file which will have the metadata of the contents to be uploaded. This page is basically divided into two sections:

Section ‘Upload Meta Data File’: this section has a file upload control to browse for the file to be uploaded on the server. This file will have meta data information of the contents to be uploaded. The supplier will be allowed to upload files with specific extensions mentioned in the configuration file. For example: .csv, .xml, .txt, xls. Other extensions may not be allowed. In addition to the File upload control, this section will have a command button ‘Upload’ to submit the selected file on the client machine. The file will be uploaded on the server at a configurable path. At this path, a folder will be created by the name of the vendor ID. So this folder will have all the files uploaded by the supplier. For example, if the vendor has ID=5 and the configurable path is given in Web.Config file as <add key=“GoGoMoContentPath” value=“C:\GoGoMo”/> then at “C:\GoGoMo” a folder by the name ‘5’ will be created, and all the files uploaded by the vendor will be stored there.

Section ‘Track Status’: This section will have a grid which will give status of the contents uploaded. The status of the contents can be either of the following
(1) In Process
(2) Ready
(3) Published
(4) Failed
(5) Conflict
(6) Pending Approval
(7) Rejected.

This grid will be shown in form of a drill down showing contents specific to the batch. Each parent node will represent a different batch. If data about number of batches are available then this grid will have number of parent nodes. The children of these nodes will be contents or messages which are uploaded or whose upload process is in progress. The data for these child nodes will give details like the title and the content type of the message. It will have a Status column which will show the status of processing. The status column will have statuses listed above.

If the i_UpdateMode flag of the Supplier in the vendor table (gogo_vendor) is set to 0, then the publisher has to manually assign the newly added contents to the subscribers. In this case, after the status of processing of contents is set to ‘Ready’ then a ‘Publish Content’ button is seen instead of the status. The user will be able to Publish the selected contents. Publishing the contents means setting the ‘flgStatus’ in the ‘gogo_ingestion_msg’ table to Published and adding the rows for that content in the gogo_content and gogo_subcontent table and setting the flag ‘i_content_status’ to 1. In addition to the grid, ‘Publish All Ready Contents’ button will be provided to publish all the ready contents in the published state. This button will be available only when the i_UpdateMode flag of the Supplier in the vendor table (gogo_vendor) is set to 0.

If the i_UpdateMode flag of the Supplier in the vendor table (gogo_vendor) is set to 1 then the components that are used to upload the contents will set the status of the ‘Ready’ contents to ‘Published’ automatically. In this case the publisher does not manually publish the newly uploaded contents.

Tables Used: gogo_vendor, gogo_ingestion_batch, gogo_ingestion_msg

Overall flow: The overall flow is explained as below
(1) The logged in publisher clicks the ‘Manage Ingestion’ tab and opens the ‘Manage Ingestion’ page.
(2) The user selects a metadata file and clicks on the ‘Upload’ button which begins the upload process.
(3) The server dynamically creates the object that will be used to upload the contents for the Publisher. ‘v_Auto_Cmp’ in the gogo_vendor table will be used for the purpose which has data stored as type, assembly name.
(4) [Out of Scope of VA] The component will first validate the uploaded file if the file is according to a specific schema. After this check control returns back to the vendor application and this status (of the file) will be shown on the page as a label. At the background the components adds row in the ‘gogo_ingestion_batch’ table indicating a separate batch. And after this rows are added in the ‘gogo_ingestion_msg’ table indicating individual contents. The status column ‘flgStatus’ in the ‘gogo_ingestion_msg’ table will be updated by the component.
(5) Once the status of the file is updated (valid or invalid) the user may browse to some other page also. However if the user continues to be on the same page the status of the msgs will be shown in the grid.
(6) Showing of ‘Publish’ command button will depend on the i_UpdateMode field in the vendor table as explained above.
(7) If data of more than one batch is available then the data will be shown in the grid as different nodes.
(8) If i_UpdateMode is set to 0 and the user clicks the ‘Publish’ button, then the status of the content in the ‘gogo_ingestion_msg’ table is changed to ‘Published’ and the status field in the subcontent table will be set to 1.
   ‘Settings’ Page: this page will show the vendor information. The vendor will be able to edit the information by clicking the ‘Edit’ button. After clicking the ‘Edit’ button, the page will be opened in ‘Edit’ mode and the user will be able to edit the vendor information. The vendor information will include the following fields: 1. First Name: Compulsory, 2. Last Name, 3. Description, 4. Address, 5. City, 6. State, 7. Country: US, 8. Postal Code, 9. Contact Number, 10. Contact Number 2: according to US phone number format. Regular Expression=̂[2-9]\d{2}−\d{3}−\d{4}$, 11. Site URL: compulsory, Regular Expression: http(s)?://([\w-]+\.)+[\w-]+(/[\w-./?%&=]*)?, 12. Fax: according to US phone number format. Regular Expression=̂[2-9]\d{2}−\d{3}−\d{4}$, 13. Email ID 1: Compulsory and Regular expression=̂\w+@[a-zA-Z_]+?\.[a-zA-Z]{2,3}$14, Email ID 2: Regular expression=̂\w+@[a-zA-Z_]+?\.[a-zA-Z]{2,3}$.

The above fields will be visible to all types of logins. In addition to these fields the settings page will have the following. Checkbox for Update new contents automatically to the resellers: if selected the flag will be set to 1 (i.e., automatically update the new contents). This checkbox will be visible only to the Publisher and ‘Publisher-Reseller’ logins. Tables Used: gogo_vendor.

Section ‘Configure Applications for Auto Update’: This section will be visible only to the ‘Reseller’ and ‘Publisher-Reseller’ login. This section has 2 listboxes. One listbox on the left will be used to list the applications of that vendor for which the autoenable feature is not set. The listbox of the right hand will display the list of applications of the vendor for which the ‘Autoenable’ feature is set to true. Command buttons will be used to move the application from one list box to other like ‘>’—to move the application from left listbox to the right listbox and ‘<’ to move selected application from right listbox to left.

Tables Used: gogo_application, gogo_appcontrol

To change the autoenable feature ‘flgAutoContentUpdate’ field of gogo_appcontrol will be used. To get the Reseller's application gogo_appcontrol table will be used.

Database tables that will be used
(1) gogo_vendor
(2) gogo_content_type
(3) gogo_category
(4) gogo_content
(5) gogo_subcontent
(6) gogo_ingestion_batch
(7) gogo_ingestion_msg
(8) gogo_map_ingestion_msg_subcontent
(9) gogo_reseller_subscription
(10) gogo_subcontent_NOT
(11) gogo_application
(12) gogo_appcontrol.

With such an application available to both content suppliers and content users (e.g., operators), digital content may be queried, fetched, adapted, and delivered according to any schema known or developed between two platforms. In addition to providing a universal “go-between” for content suppliers and content consumers, the content registry may also provide a basis by which digital content is tracked. Each specific instance of a digital content may be further associated with a UDC that includes a number of pieces of data that identify specific parameters about the instance of the digital content. For example, the UDC may have data that indicates the name of the underlying digital content. Another piece of data may be indicative of the origin of the digital content (e.g., the content supplier). Still another piece of data may be indicative of the channel in which digital content may delivered, e.g., downloaded from the content registry to a Sprint mobile phone. Numerous other examples of data are possible but not discussed here for brevity.

The UDC may be used to assist in identifying even more associations, such as all digital content by the same title, or by the same artist, or downloadable to the same device, or from the same content supplier. Virtually any relationship may be drawn from the data stored in the content registry and may typically be assembled in real-time (sometimes called at run-time) such that data about the relationships need not itself be stored in a permanent manner. Some associations may be specific rules for transducing digital content from one format to another such that once the rule is established for one type of format change, any future required format changes for this type may simply reference the association that is stored in non-volatile memory for future reference.

Further, specific device parameters may be stored in the content registry such that rules may be established during a run-time query. The rules established can also be stored for use and rules may even be ingested by the content registry from content suppliers who may wish to prohibit specific uses of their digital content, such as a ringtone exclusive to Sprint users may be prohibited by Cingular® users. Further yet, instructions specific to a user's device may also accompany the delivery of the digital content.

Thus, the content registry provides a means by which content suppliers and content consumers need not deal directly with the other in order to provide digital content from supplier to consumer. With the sheer number of suppliers and operators, keeping track of all the different schemas and protocols becomes prohibitive. Using a common content registry that has assimilated a supplier's digital content in a known procedure and storage schema allows the content registry to manipulate the underlying content for delivery to any operator platform.

The Content Registry enables content interoperability, including superdistribution, giving providers the flexibility, control and viral capabilities like content referral and gifting services while protecting and managing policy rights. Providers can now more effectively control widespread content distribution through real-time tracking of digital transactions including where it goes and who gets access while ensuring payment and usage rights across users, devices and other carrier networks. This proposed solution delivers reliable and easy-to-use technologies that leverage historical investments to drive immediate results.

Policy and Rights Management

The Policy Management System may enable the support of DRM permissions, maintain DRM-specific and other policy attributes within the content registry, and establish and enforce rules and associations for those specific attributes. The content registry leverages a policy and rights management system enables the support of distribution and DRM permissions, maintains policy-specific attributes within the meta data registry, and establishes and enforces rules and associations for those specific attributes to determine the rights of use of the meta data.

Policy Registration for Content Providers:

As part of process of Content Suppliers registering and submitting content metadata into the content registry, Content Suppliers are able to apply policies to their content.

Policy Registration for Mobile Carriers:

As part of process of metadata submission and management, Mobile Carriers are able to create policies regarding their services and for specific content, depending on the policies registered by the Content Providers within the content registry. Policies are additive in nature, providing the ability to manage content both by the provider and channel policies. In particular with regard to chained identifier, the policies associated with each identifier, may also be additive, such that later identifiers inherit the policy of their parent identifiers.

Policy Tracking:

Content Suppliers and Mobile Carriers are able to view, update and delete their Policies through a content publisher management tool in various embodiments.

Publishing:

Once a Content Supplier or Mobile Carrier completes the process of creating a Policy, it must then be published to the content registry. The content Policies and rules become available to be discovered from multiple relevant areas of the content registry, including authorized other Content Suppliers and Mobile Carriers. These policies must be persistent and govern the various use of content stored in the content, e.g., Consumption, Referral etc.

Policy Definitions and Classifications:

Once Content Supplier policies are submitted and published to the content metadata registry, the content registry system must provide a facility to create definitions and associations for Mobile Carriers to use to create derivative services based on the associated polices and rules which will govern their offerings.

Content Publisher Management:

Web-based tools must be provided to allow management of services and content offerings on attributes of the content and their association, including policies and compatibility of content for territories, handsets, carriers and service providers.

In one embodiment, XML-based policy files are managed directly by a “rulebase” subsystem. The rules engine should dynamically calculate associated content policies in real time. In this mode, the provisioning process must wait for authorization from the policy system before proceeding with content delivery to the subscriber.

Such a policy system has the potential to encapsulate a large and diverse inventory of mobile content that is capable of serving a large variety of devices, networks and operating systems through its content registry.

This metadata management platform is built using an object-oriented approach and is more flexible because it allows for the dynamic creation of new types of objects and new types of relationships between them and dynamically maps content to devices while protecting and managing digital distribution through a vendor driven policy rights management framework. Traditional relational databases cannot adequately address this problem because they rely on the types of objects and the types of relationships between them being known in advance and built into the system design. Since new types of objects and relationships are appearing often in this space, a solution built using the relational approach will not be able to keep up and to scale.

This Classification System formally defines the hierarchies and relationships between different attributes creating a system of classification that makes it very easy for the platform to scale quickly in entering in a new content type or device.

Association Database stores, finds, interprets, combines and acts on information for multiple contents, devices and their associations. It also allows creation of new associations that can generate new content. A partial listing of an exemplary digital content registry includes content structures, device structures, and policy structures within registry, such as:

Registry Logical Components:—
(1) Content Schema & Data—Embodies different types of digital content
(2) Device Schema & Data—Embodies different types of digital devices
(3) Policy data—Rules associated with the content & its consumption
(4) Associations—between various system entities
(5) SubSet of registry interfacing applications:—
(6) Policy engine—Enforces rules associated with content consumption
(7) Compatibility engine—Calculates content instances based on network, devices, and other associations.
(8) Reporting—Pre defined set of reports on registry data for participating providers
(9) Automated content ingestion system—dynamic ingestion of digital content from various aggregators.

External users may be related to a player-based content registry in a variety of manners, including:
Supplier—A supplier supplies content into the registry. Consumer can be a supplier if he supplies his own content
Reseller—A reseller resells content from the registry by advertising links into the registry, or through his own website, or any other medium. Consumers can also be resellers by personalized storefronts.
Consumer—Who consumes the content with the help of the registry

XML code schemas are used for content within the registry. This can possibly be transformed into a object-oriented microformat for setting the metadata standard for all digital content. The registry uses a number of schemas and their associations to accomplish advanced digital content management. Following is the exemplary code schema,

Exemplary code samples for implementing the above are included in APPENDIX B.

@ Transition

With reference to FIG. 1, an exemplary embodiment involves a content identification system 100 for digital content, as well as methods of storing, retrieving, aggregating, and associating identifiers and content. FIG. 1 illustrates one embodiment by way of a diagram of interconnected devices. In this instance, a registry server 300 uses a database 360 and a set of functions and procedures for storing, retrieving, and maintaining relationships in the database 360 to implement an exemplary embodiment.

One feature of the content registry system 100 and, particularly, registry server 300, is the ability to identify the content its source out through a chain a vendors, such that respective members of the provider chain can grasp a picture of how digital content is being distributed. As each content record is adapted to contain its respective vendor and source information up to its origin, it is possible for providers throughout the chain to determine respective debits and credits associated with the provision of the digital content.

UDCs

In various embodiments UDCs may take many forms. However in some exemplary embodiments it may be beneficial to allow for both user-generated and online registry generated UDCs. Furthermore, in such potentially user-generated UDC embodiments, the use of a globally unique identifier (“GUID”) to tie commonly sourced content together may allow for a more efficient and useful UDC system. In general, a GUID is a 128-bit value known by those skilled in the art to be effectively unique. A GUID may be generated using a presently available GUID function (e.g., the newid( ) function of the Microsoft® SQL Server™ database server application). In turn, the newid( ) function uses an application programming interface such as CoCreateGUID( ) to create the GUID. Further descriptions of a GUID (alternately known as a UUID) may be found in IETF RFC 4122 which is hereby incorporated by reference.

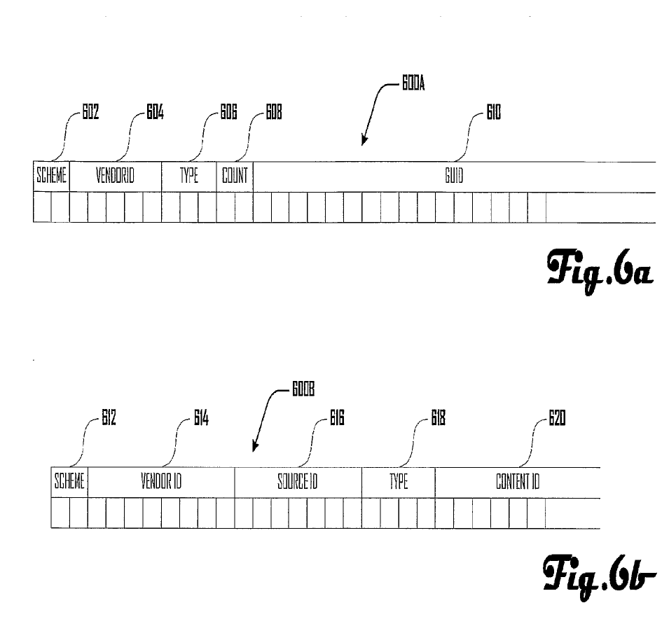

Examples of the uncompressed UDC 600A are illustrated in FIG. 6a and may include a Scheme 602, VendorID 604, media type 606, Counter 608 and GUID 610.

Scheme 602—We will reserve some codes in the scheme digits. Rest can be kept open for interpretation by vendors. (Size ˜4K)

VendorID 604—5 character code which will be assigned by the registry. Can be something like a unique email userid used by existing email systems. In some embodiments, a CAE code or IPI (interested parties information) number may be used for a VendorID. (Size ˜1 Bill.)

Media type 606—Will be controlled by gogomo for standard media types. GoGoMo will be open for registration of new MT as registry grows. The list will be made public. (Size ˜260K)

Counter 608—Will be used to distinguish m/p derivates of the same content. Will be assigned by vendor. Maintained by vendor. If assigned by GoGoMo, we will start with a reverse order. (Size ˜4K)

GUID 610—Base64 encoded GUID uniquely identifying source of the media type. In some embodiments an ISRC, ISWC or GRid may be used instead of a generated GUID as they will provide a sufficiently unique identifier as well. (Size—22 digits, 2¹²⁸)

This allows a 34 digit code allowing primary source traceability and report reconciliation. With chaining for complete traceability, each link in the chain only adds 12 digits. For example:
Level 1—34
Level 2—46
Level 3—58
Level 4—70
And so on.

For example if a content creator (e.g., “The Rolling Stones”) has content (e.g., the song “Start Me Up”) that is owned by a record label (e.g., “Virgin Benelux B.V.”) a particular version of the content (e.g., the version on the album “Tattoo You”) would be a good source piece of media content and probably the source version of derived versions of the media content (if not derived directly from a master version that was used to create the album version). Therefore using such a GUID UDC scheme would allow derivative versions of this UDC content to maintain a similar UDC, namely using the same GUID.

For example a UDC of an MP3 created from the source of “Start Me Up”

might look like: 12-000A0-Bx5-05-7QDBkvCA1+B9K/U0vrQx1A. The respective fields in the UDC separated by dashes would be in their respective order indicator for a scheme, vendor, media type, counter and of course the GUID. A scheme may indicate how the UDC was created and for what purpose, e.g. a vendor-created UDC. The vendor (e.g., Virgin Benelux BV) meanwhile would be an identifier of the entity providing the content identified by the UDC to consumers (or possibly other vendors). The media type would describe the format of the content (e.g., an MP3 sampled at 320 bps). The counter allows for different versions of similarly schemed, vended and media typed content, for example, in the song “Start Me Up” a vendor that has created a ringtone may create multiple ringtones from different parts of the song. The counter would allow for a differentiation between the separate ringtone. In one embodiment a UDC created by the vendor would increment from the bottom and a UDC created by a registry would decrement from the back so as to allow each to create separate versions of UDCs with a minimal chance of a “collision”. Finally, the GUID is a globally unique identifier that is unlikely to have a chance for a collision. In general, a GUID may be 128 bit pseudo-randomly generated number that, while not guaranteed to be unique, has such a large number of unique keys that the probability of the same number being generated twice is very small. It may be beneficial to have UDCs that are relatively short and yet still represented via conventional characters, accordingly a “base64” encoding of the GUID allows it to be encoded as a string of 22 characters and still represent all 128 bits.

The UDC could be used as a common source UDC or could be chained with additional scheme/vendor/media type/counter data to create chained UDCs that trace the vending of the UDC from one vendor to the next. For example, if Virgin Benelux provides the “Start Me Up” content to Cingular wireless as a ringtone, the UDC may have additional scheme/vendor/media type/counter data included. For example:

12-000A0-Bx5-05-7QDBkvCA1+B9K/U0vrQx1A-12-011Bm-Bx5-01.

This would show that the Virgin Benelux content was licensed to Cingular wireless such that when it was vended to consumers the content was traceable back to Virgin Benelux.

In some embodiments, various compression algorithms may be used. However, compression would produce a Uniform Compressed Code (“UCC”), and it might not be attractive to the participants as the GUID would no longer be the same amongst similarly sourced pieces of content.

Also, the tracing can be represented in a registry or other database. Each record of derived version of the content may “point” back or otherwise refer to the version of the content that it was derived from. This would allow for the dynamic generation of UDCs from the relationships between versions to the content. Other versions may include:

Following are in one exemplary alternate embodiment the UDC may be formed of all hex digits (0-9A-F).

So in order to have 11 bytes it will need 22 slots,

Scheme-Vendor ID-Media Type-Content ID

XX-XXXXXXXX-XXXX-XXXXXXXX

This will support 256 Schemes, 4 Billion Vendors & Content IDs and 65K Media types.

### EXAMPLES

11-ABCD1234-2345-2345CDEF {Scheme 11 may indicate Premium content & UDC assigned by GoGoMo}

12-ABCD1234-2321-0000234F {Scheme 12 may indicate Premium content & UDC assigned by Vendor himself in his preferred order. Note it is the same vendor.}

13-00012345F-2345-2345CDEF {Scheme 13 may indicate UGC & UDC assigned by GoGoMo}

11-ABCD1234-FF34-2345CDEF {Media type FF34 may indicate Bundled content produced by vendor & tagged by GoGoMo. This does not cover what is contained in the bundle.}

One alternate embodiment allows for compressed forms of UDCs. For example a UCC (Unified Compressed Code). The UCC would be passed from one point to another. UCC would allow chained information of UDCs. In one embodiment a UCC will be formed by UDC compression using a publicly available or a proprietary, compression standard.

In one example:

UDC 1=11-ABCD1234-2345-2345CDEF

UDC 2=11-11223344-2345-12344321

UDC 3=12-12345234-2345-1234ABCD

Suppose, UDC 1 is created by Vendor 1, derived by Vendor 2, which is further derived by Vendor 3

Compression would proceed as follows:

UCC 1=424235363463634637745408583450985390583059 and is created by compressing UDC 2 and UDC 1 (11-11223344-2345-12344321, 11-ABCD1234-2345-2345CDEF).

UCC 2=1221313213123213133131313121321313123 and is created by compressing UDC 3 and UCC 1 (12-12345234-2345-1234ABCD, 424235363463634637745408583450985390583059).

Decompression would proceed as follows

UCC 2=1221313213123213133131313121321313123

Decompress once provides UDC3 (12-12345234-2345-1234ABCD) and UCC1 (424235363463634637745408583450985390583059)

Decompress twice provides UDC2 (11-11223344-2345-12344321) and UDC1 (11-ABCD1234-2345-2345CDEF)

Such an embodiment can handle chains of UDCs.

Under similar logic, it is possible to modify the UDC 600B to be 15 bytes (30 slots) as illustrated in FIG. 6b. In FIG. 6b the UDC includes: Scheme 612, Vendor ID 614, Source ID 616, Media Type 618 and Content ID 620. By including a Vendor ID 614 and Source ID 616 it is possible to “traverse” the registry by the providing source and determine the relationships between various content providers much like a bidirectional linked list in a computer software program. This will help in tracking resellers without requiring a check of a registry.

Content Ingestion

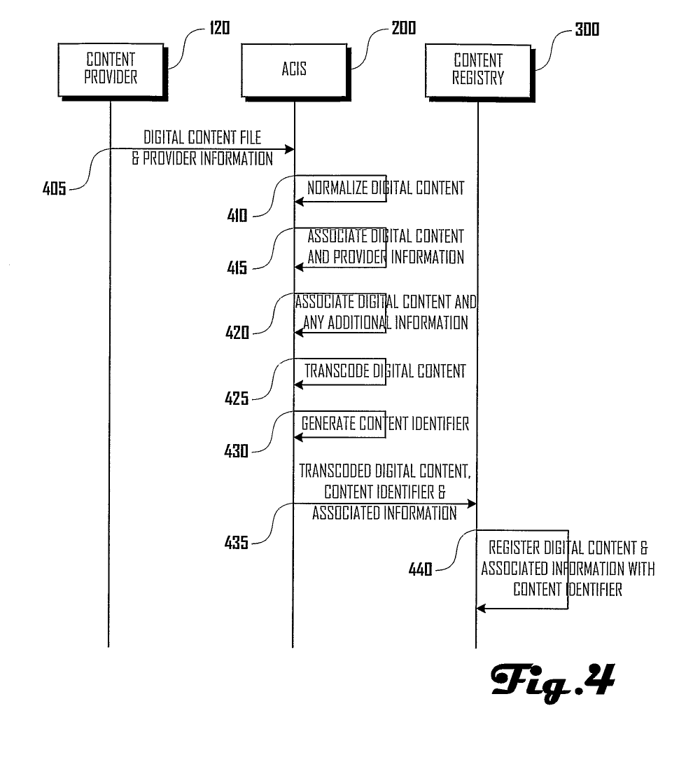

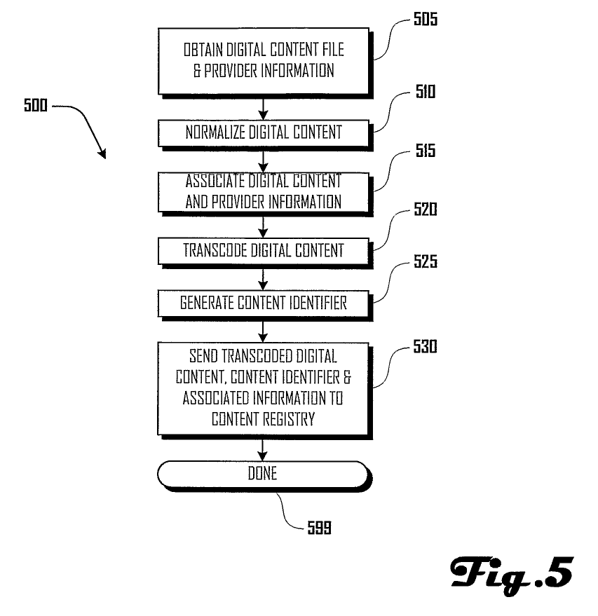

FIG. 4 illustrates an exemplary “ingestion” transaction between a content provider 120, ACIS 200 and content registry 300. In the exemplary transaction in FIG. 4, the transaction begins with the digital content file and provider information being sent 405 to the ACIS 200. The ACIS then begins the ingestion process (describe below in greater details with regard to FIG. 5) by normalizing 410, associating 415 & 420, transcoding 430 generating an identifier for 430 and sending 435 for registration the ingested digital content.

FIG. 5 illustrates an embodiment of a process 500 for ingesting digital content and metadata that involves several steps. The content ingestion process commences (step 505) with obtaining of associated metadata and optional digital content from a content supplier 120, and the subsequent normalization of the data (step 510). The principal purpose for normalizing the received data is to ensure consistency in the format of data stored in the ACIS 200 and to accommodate the receipt of digital content and associated metadata in a wide array of formats. It is anticipated that content and metadata about such content will be received on an ongoing basis as content suppliers register new content and as subsequent owners, authorized licensees and distributors register their interests in the previously registered content. In an embodiment, the normalization process executes automatically to actively retrieve content from content sources and to update existing content in the ACIS 200. It is contemplated that each party involved in the reproduction or distribution of the digital content will register metadata confirming their interest in the content in the content registry 300.

The received data will be associated (step 515) after normalization to preserve the specific associations between content and data in a manner consistent with the object-oriented paradigm discussed above. Associations are computed in a dynamic manner at runtime upon execution of the registration and ingestion process. After association of data, it will be transcoded (step 520) for delivery onto one or more devices or for compatible operation with different applications to ensure the seamless purchase experience required by end users. Upon completion of the transcoding process, a content identifier (such as the UDC described below) is generate in step 525. Next, the data will be sent to be registered in the content registry (step 530) and the content ingestion process will be completed (step 599). It is important to note that upon initial receipt of content or related metadata the data will be “ingested” in the content registry 300, while receipt of the same content or related metadata (e.g., name of artist, name of musical selection, etc.) from subsequent parties (e.g., authorized content licensees, ringtone distributors, etc.) will be deemed “registered.” The initial ingestion of content or related metadata will result in the creation of a UDC and each subsequent registration of related metadata in the content registry 300 will be assigned a unique UDC for tracking and management by the registering entity.

In an alternative embodiment of the ingestion process, the retrieved data may be converted into a proprietary format to more efficiently identify missing parts of data during the association process and to enable rapid cross-indexing of content with device-specific databases prior to the ingestion and registration of the data into the content registry 300.

Content Supplier Registration.

In an embodiment, registration of a new content supplier in the system is performed manually. The content supplier will specify the modes of retrieval of metadata and content. Among the different ways and protocols used for metadata retrieval include, but are not limited to, HTTP (hypertext transfer protocol), HTTPS (hypertext transfer protocol secure), authenticated http(s), web service call, FTP (file transfer protocol) Site, Manual uploads, electronic mails etc. Various different ways of content retrieval can include FTP Pull, Periodic FTP Push, HTTP Pull, direct upload using Sync Client etc. Content may also not be available at the time of registration. In this case, dynamic retrieval information is supplied by an HTTP call or web service call. The available metadata is presented in multiple different formats like structured XML, unstructured XML, excel tables, flat files, etc. In an alternative embodiment, components encompassing various technologies can be provided to convert these disparate feeds to XML based on standardized schemas. These standardized feeds are then split into messages which are subsequently fed into the ACIS 200.

After the initial one time setup by the content supplier, these components are run as a hosted service which will periodically check for metadata from the content suppliers and generate alert messages to the ACIS 200 when such metadata is available.

In an alternative embodiment, the ACIS 200 can alternatively be triggered by manual uploads of metadata using an application such as Publisher Central, direct public API calls, admin applications, or other user applications like a device sync client which uploads user generated content from various devices like PCs, mobile handsets, PSPs etc. In yet another embodiment, the ACIS 200 can be used to ingest user generated content using a web interface or the device sync client. Data can be received a disparate array of data feeds and in one embodiment such feeds may be provided by content suppliers such as Wider Than, Mobile Streams or Media Lead, among many others.

Structure of the ACIS

The operation of the ACIS includes a policy management component 280 implements the platform and behavioral policies of the ACIS 200. The association component 280 directs and maintains the associations between and among content, metadata, applications and target devices. The content polling component 285 actively polls a plurality of content sources to ensure that any new content is promptly ingested into the content registry 300 and available for subsequent delivery to end users and/or devices. The transcoding component 270 manages the transcoding of content and metadata for designated target devices and/or applications and stores such transcoded content in the MEMORY 250.

Operation of the ACIS

In an embodiment, the ACIS 200 comprises a multi thread application which can handle content ingestion of messages. The ACIS 200 can automatically understand the type of the message (e.g., single content, bundled content, user generated content, transcoding required content, etc.) It dynamically triggers components which are designed to handle all these various scenarios. Following are some use cases relating to ingestion.

In various embodiments, the ACIS 200 is also operative capable of Automatic Feed Acquisition & Scrubbing. This enables the ACIS 200 to do automatic updates to the content registry 300 as and when data is available from source publishers. Below is the process involved:
(1) Feed Acquisition system s configured to acquire feeds on a periodic basis. All different time units like seconds, minutes etc. are supported. At the preset time intervals, the system checks for updates via networks like internet and acquires latest feeds from the publishers. These feeds are then fed into the scrubbing system.
(2) The input feeds are validated & scrubbed for data. This is done in a unique way by which new & updated contents are determined. The data feed is split into content messages. Each feed could potentially have several thousand messages. These messages are fed into the ACIS system.

The ACIS 200 works with parallel threads, each independently responsible to handle a different feed, all at the same time, thus, enabling a robust scalable feed handler system.

Each time a new publisher is registered in the content registry 300, three components are set up, which are plugged in the workflow engine of ACIS 200.
(1) Feeder—Acquires feeds
(2) Scrubber—Does initially scrubbing of the feed to generate messages compatible to registry schema.
(3) Deliverer—Understands delivery of content with regard to the publisher

Data Sync Services—These services run on the registry and are responsible of injecting metadata into various the applications and systems from the content registry 300.

Single Content Piece—The ingestion component first tries to retrieve content from the remote source specified within the message. There could be several different methods of retrieval as described above. These are handled by several handlers associated with each scenario. After the content retrieval, content metadata is normalized to fill in missing content within the message by talking to propriety and any third party services like a CDDB (e.g., Gracenote® or FreeDB). A CDDB is an online database of CD album, artist, track, and genre information. Software programs can make a request of the CDDB to download CD information for automatic track naming in the program. This is particularly useful for ripping CD audio and having your tracks named automatically rather than manually. Computer CD programs, like the one that comes with often automatically request CD album and track information for you to view through the CD playing program.

Next, the content is matched with the contents available in the object-oriented database to figure out redundancies and collisions. A “collision” is a phenomenon which occurs when and if the same content is identified based on attributes like similar titles etc. A collision can be resolved by a system administrator to preserve better metadata. After content matching, content associations are created based on various formats for information available within the metadata. This dynamic association creation is based on object-oriented technology of attribute mapping. These dynamic associations are later used to compute accurate content for a particular device, network etc. Afterwards, various associated policy rights are ingested for the content. Finally, a UDC is generated for the content based on the supplied information. This UDC is used to track the content in various transactions.

Bundled Content—Content delivered within a bundle is separated out and inserted into the content registry 300 as described above. Afterwards, semantic associations are created between these content items and persist as a bundle in the object-oriented database. Alternately, some digital content file may be kept bundles with a single identifier.

User Generated Content (“UGC”)—UGC can be inserted into metadata by means including by use of a web interface or client tools. Each such inserted UGC is associated with a particular user and the UGC is mapped to create associations for it to be available on a maximum number of devices. A UGC may require an additional step of approval by a system administrator. The UGC inserted can potentially be priced and put into the user's storefront or the common marketplace for sale by the user.

Transcoding—In the physical good space, this is next to impossible. Digital content provides a unique opportunity for transcoding to different devices. If the message specifies that transcoding is required for a particular content piece to target a format or a device, then the associated component is invoked and a new content with a separate UDC is generated.

In various embodiments, the ACIS 200 is also operative capable of Automatic Feed Acquisition & Scrubbing. This enables the ACIS 200 to do automatic updates to the content registry 300 as and when data is available from source publishers. Below is the process involved:
(1) Feed Acquisition system s configured to acquire feeds on a periodic basis. All different time units like seconds, minutes etc. are supported. At the preset time intervals, the system checks for updates via networks like internet and acquires latest feeds from the publishers. These feeds are then fed into the scrubbing system.
(2) The input feeds are validated & scrubbed for data. This is done in a unique way by which new & updated contents are determined. The data feed is split into content messages. Each feed could potentially have several thousand messages. These messages are fed into the ACIS system.

The ACIS 200 works with parallel threads, each independently responsible to handle a different feed, all at the same time, thus, enabling a robust scalable feed handler system.

Each time a new publisher is registered in the content registry 300; three components are set up, which are plugged in the workflow engine of ACIS 200.
(1) Feeder—Acquires feeds
(2) Scrubber—Does initially scrubbing of the feed to generate messages compatible to registry schema.
(3) Deliverer—Understands delivery of content with regard to the publisher

Data Sync Services—These services run on the registry and are responsible of injecting metadata into various the applications and systems from the content registry 300.

ACIS Batch Operation

In yet an additional embodiment, each upload of content and/or metadata can be treated as a batch of messages. Content suppliers 120 can report and track the status at the message level within the ACIS 200. Various batch messages can be provided including the following:

public enum BatchMessageStatus

{

Init,
InProcess,
Ready,
Published,
Failed,
Conflict,
PendingApproval,
Rejected

}

Reporting

All activities related to the content registry are kept in the database as transaction and event records, which include transaction records, events within the content registry, and statistics for later diagnostics and reports. content registry systems health is monitored by multiple services which emit system related events and data, e.g., performance counters including % Memory used, CPU utilization; custom counters such as number of messages ingested, and average message processing time.

Event Archive and Possible Actions:

Each content registry component issues events. These events provide information about activities in the content registry. The events are logged using standard event logging mechanisms. In case of a failed action or event, the content registry reports the problem description for diagnosis and appropriate action.

Audit Trail:

Actions performed by Content Providers and Content Channels and transactions within the content registry are recorded by the content registry. These actions can be audited by the content registry and administrators of the content registry.

Statistics and Reports:

Statistical information is gathered from the content registry and stored for reporting and reports for Content Suppliers, Content Channels and administrators. Statistics data includes ingestion metrics, recommendation statistics, registry dips info, incomplete referrals, usage statistics.

Statistics Collecting:

Within the content registry, statistic information is continuously collected and stored within the database. All data can be shown to administrators and power users using standard reporting mechanisms.

General Reporting:

The content registry includes a reporting utility that enables generation of various reports based on collected statistics. Reporting components may execute on an asynchronous database for high performance data mining. The content registry Reporting service operates through a WEB tool, which can be used by the customer care or marketing division, allows Content Suppliers to view statistics information. Reporting services include standard on demand reporting and parameterized custom reporting. Content registry can also provide periodic scheduled reporting to Emails, File Shares including exporting the data in multiple formats—Excel, XML, CSV, PDF or the like.

ACIS Interfaces.

In this system, a number of interfaces are provided for the manual and dynamic entry of content and metadata. These interfaces ensure that such content is not only stored but actively updated and made available in different transcoded formats for different devices, platforms and applications. Among the interfaces that are available to the system are vendor specific interfaces, automated services that autonomously interact with and retrieve new content from various content sources, an application programming interface that is invoked dynamically to retrieve content and metadata, an administration application that enables a content administrator at various content sources to transmit data to the ACIS 200 for ingestion in a “brute force” manner and a client application interface that enables end users to register user generated content. The client application interface enables end users who generate content to register the content in the content registry 300 and to assign it a UDC. In addition to content registration, metadata related to the content (e.g., name of artist, name of musical selection, target devices, etc.) may be provided for ingestion using the client application interface.

More specifically, various user interfaces (not shown) can be used to deliver content and related metadata to the ACIS 200, including Publisher Central, Public SOAP API, administrative applications, user applications, or an automated “updating” service. A representative example of the interfaces and their use in communicating content and metadata to the ACIS 200 for ingestion into the content registry 300 is shown in FIG. 6.

Publisher Central (described below) is a software application associated with the content registry 300 that allows for easy navigation and access to the data stored therein. The user of this application may have a role of publisher, reseller, or combination of both (publisher/reseller). Depending on the role of the logged on user, the contents of the presented data will change.

The default page for this site may be a login page. On each of the pages, checks may be made to see if the user/vendor has logged in or the session is active, else the user may be redirected to the login page. The login page enables vendors to log in to the Vendor Application system after entering the Email ID and password. This page may further include a ‘forgot password’ link. Upon clicking the ‘Login’ button, the authentication of the user takes place. Depending on the role of the logged in vendor, he/she will be shown a page. Irrespective of the role of the logged in user, the user will first be taken to the ‘Home’ page.

Among the tables that can be used for log-in identification are as follows:

The header section for the Publisher login may include tabs entitled as follows: 1. Home, 2. Manage Contents, 3. Manage Subscription, 4. Manage Ingestion, and 5. Settings.

The header section for the Reseller login may include tabs entitled as follows: 1. Home, 2. Manage Subscribed Contents, 3. Manage Subscription and 4. Settings.

The header section for the ‘Publisher—Reseller’ login may include tabs entitled as follows: 1. Home, 2. Manage Contents, 3. Manage Subscribed Contents, 4. Manage Subscription, 5. Manage Ingestion, and 6. Settings.

The publisher central provides a web interface to manually upload metadata into the ACIS 200.

The following is a synopsis of the steps in the operation of this system, the content ingestion process from a content supplier's perspective and the workflow engine used to implement content ingestion:

System Operation:
Feeds from content suppliers are described in feed files, which are raw ASCII text files that use at least one of the file formats/extensions: TXT, CIF, XML, and CSV.
Proprietary XML format is applied for capturing metadata information.
Classification of a feed message item:
   New Content
   Blocked Content
   Substitute Content
Data Scrubbing—Reactive data scrubbing for scalability

Content Ingestion Process:

New Content Supplier:
New Content Supplier Setup
Create Ingestion and Delivery Adapters
XML Validation—Automated feeds may be rejected if it fails the schema validation.
Push to CI Workflow Engine Queue
Publish ingestion and delivery components
Update Admin and Vendor

Existing Content Supplier:
Automated XML Feed updates via API Service
Using Update Adapters to generate GoGoMo XML—Feeds may be rejected; Admin is informed of the Exception
XML Validation
Parse transformed feeds and push to CI Engine Queue
Update Admin and Vendor

Content Ingestion Workflow Engine:

Process Feeds
Read Normalized XML for Input Queue
Pull Pullable Content Data on to File Server
Update the XML Message Instance
Connect to Content, Device, Content Supplier Services
Purge Content based on Content Supplier, Title
Cross Index Metadata—Produce Mappings
Convert XML to SQL Data (Pre-Production DB)
Update Content Supplier upon Batch Completion

APPENDIX A contains representative software code used in an embodiment for content and/or metadata ingestion into the ACIS 200 and registration in the central registry 300.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

1. A method of managing digital content, the method comprising:
maintaining a content registry of digital content records each corresponding to digital content file and containing information identifying said at least one digital content file based at least partially on a unique identifier of an origin of said digital content file;
generating a unique record identifier for each digital content record, said record identifiers being configured for querying said content registry, wherein said record identifiers include a vendor identifier of a vendor associated with the identified at least one digital content file and a media type identifier of said at least digital content file; and
if alternate identifiers corresponding to said at least one digital content files are provided, associating said alternate identifiers with each of the digital content records corresponding to said at least one digital content files.

2. The method of claim 1, wherein said record identifiers further include a scheme identifier.

3. The method of claim 1 wherein said record identifiers future include a counter identifier.

4. The method of claim 1 wherein a plurality of said record identifiers each includes a plurality of vendor identifiers.

5. The method of claim 4 wherein a plurality of said record identifiers each include a plurality of media type identifiers.

6. The method of claim 4 wherein said plurality of vendor identifiers is indicative of a chain of provision of the digital content embodied in said at least one digital content files.

7. The method of claim 1 further comprising ingestion said at least one digital content files into said content registry.

8. The method of claim 7 wherein ingesting said at least one digital content files into said registry comprises transcoding said at least digital content file.

9. The method of claim 8 wherein transcoding comprises formatting said at least one digital content files for delivery in a specified format.

10. The method of claim 7 wherein ingesting further comprises determining if in addition to said at least on digital content files, any of vendor identifiers, a media type, a scheme identifier, a counter identifier and a record identifier of an associated record are available, and if so, including said identifiers in said generated record identifier corresponding to said digital content files.

11. A computer-readable medium containing computer-executable instructions for performing the method of claim 1.

12. A computing apparatus containing a processor an a memory containing computer-executable instructions, which when executed perform the method of claim 1.
